(19) United States
(12) Patent Application Publication
(10) Pub. No.: US 2013/0120265 A1
(43) Pub. Date: May 16, 2013

(54) Keypad with Electrotactile Feedback

(71) Applicants: Hiroshi Horii, Pacifica, CA (US); Cynthia Kuo, Mountain View, CA (US)

(72) Inventors: Hiroshi Horii, Pacifica, CA (US); Cynthia Kuo, Mountain View, CA (US)

(73) Assignee: Nokia Corporation

(21) Appl. No.: 13/296,391

(22) Filed: Nov. 15, 2011

(51) Int. Cl. G06F 3/02

(52) U.S. Cl. 345/168

(57) ABSTRACT

An apparatus including a keypad, pressure sensors and electrotactile feedback electrodes. The keypad includes a plurality of keys. Each of the keys has a top surface. The pressure sensors are located under the top surfaces of the keys. The electrotactile feedback electrodes are located at the top surfaces of the keys.

### BACKGROUND

1. Technical Field

The exemplary and non-limiting embodiments relate generally to a keypad and, more particularly, to a keystroke sensation.

2. Brief Description of Prior Developments

Some manufactures of devices or applications which need a keyboard have eliminated providing a physical keyboard in favor of a “soft,” or virtual software-based keyboard, such as on a touch screen for example. Soft keyboards enable thinner and lighter designs for the physical device itself. There are many innovations that make soft keyboards more effective, such as SWYPE or auto-spell correcting software. However, many people still prefer a physical keyboard/keypad to enter data; particularly for large amounts of data. It is difficult to match the speed and accuracy of a physical keyboard with use of a soft keyboard.

Tablets are an interesting addition to the mobile device space. People are buying them, hoping to replace their PCs. However, the tablets' soft keyboards are not as effective as physical keyboards. Users often carry around additional physical keyboards to use with their tablets, which negates some of the benefits (thinness, lightness) of the device. Thus, there is a need for a thinner and lighter physical keyboard that can be used with a tablet or other type of device.

### SUMMARY

The following summary is merely intended to be exemplary. The summary is not intended to limit the scope of the claims.

In accordance with one aspect, an apparatus is provided including a keypad, pressure sensors and electrotactile feedback electrodes. The keypad includes a plurality of keys. Each of the keys has a top surface. The pressure sensors are located under the top surfaces of the keys. The electrotactile feedback electrodes are located at the top surfaces of the keys.

In accordance with another aspect, a method comprises providing a keypad having a main section and a plurality of keys extending up from the main section, where each of the keys comprises a top surface, and electrotactile feedback electrodes located at the top surfaces of the keys; and locating pressure sensors under the top surfaces of the keys.

In accordance with another aspect, a method comprises pressing on a top surface of a key of a keypad by a finger of a user, where the keypad comprises a main section and the key extends up from the main section, where the key comprises the top surface located above the main section; sensing pressure on the top surface of the key by a pressure sensor located under the top surface; and providing electrotactile feedback to the finger of the user by an electrode on the top surface of the key.

In accordance with another aspect, a non-transitory program storage device is provided which is readable by a machine, tangibly embodying a program of instructions executable by the machine for performing operations, the operations comprising: sensing pressing on a top surface of a key of a keypad by a finger of a user by a pressure sensor located under the top surface, where the keypad comprises a main section and the key extends up from the main section, where the key comprises the top surface located above the main section; and providing electricity to an electrode on the top surface of the key to provide electrotactile feedback to the finger of the user.

### BRIEF DESCRIPTION OF THE DRAWINGS

The foregoing aspects and other features are explained in the following description, taken in connection with the accompanying drawings, wherein:

FIG. 1 is a perspective view of an example embodiment;

FIG. 2 is a diagram illustrating some of the components of the apparatus shown in FIG. 1;

FIG. 3 is a perspective view illustrating typing by a person using the apparatus shown in FIG. 1;

FIG. 4 is a side view of the keyboard and user's hand shown in FIG. 3;

FIG. 5 is an enlarged view of an area shown in FIG. 4 with a schematic cross sectional view of the keypad,

FIG. 6 is an enlarged view of the key shown in FIG. 5;

FIG. 7 is a top plan view of a portion of the keyboard shown in FIG. 3 and a user's finger;

FIG. 8 is a diagram illustrating components of the keyboard shown in FIG. 3;

FIG. 9 is a diagram illustrating an example connection;

FIG. 10 is a diagram illustrating two sensations being combined to provide a unique combined sensation of a vertical key-stroke;

FIG. 11 is a diagram illustrating an example embodiment;

FIG. 12 is a top plan view of an alternate example of a keypad;

FIG. 13 is a perspective view illustrating an alternate embodiment of a key;

FIG. 14 is a diagram illustrating an example method;

FIG. 15 is a diagram illustrating an example method;

FIG. 16 is a diagram illustrating the keyboard as a standalone apparatus and showing a connection to another device; and

FIG. 17 is a diagram illustrating another example embodiment of the keyboard.

### DETAILED DESCRIPTION OF EMBODIMENTS

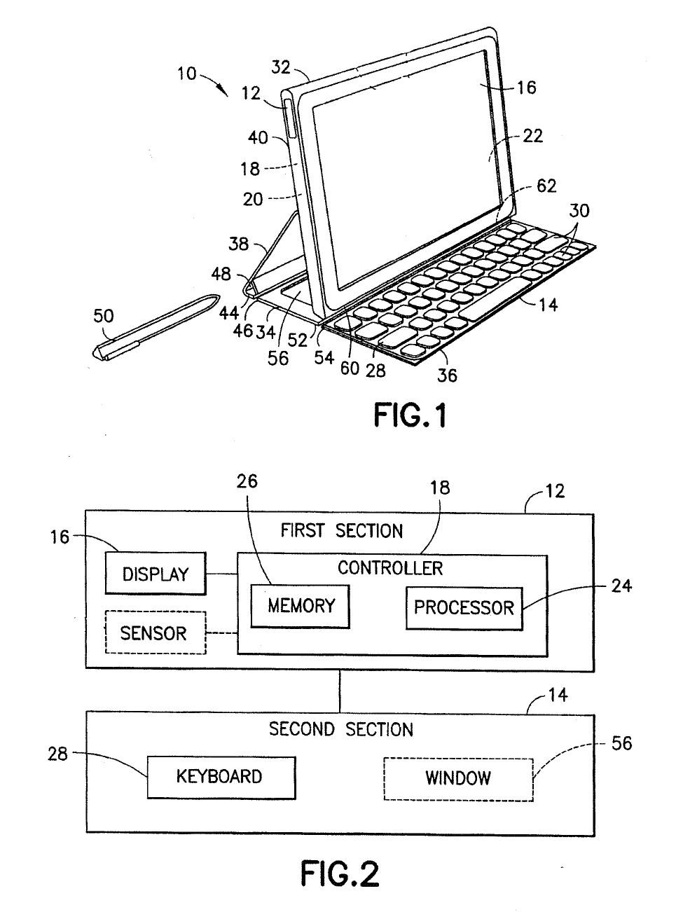

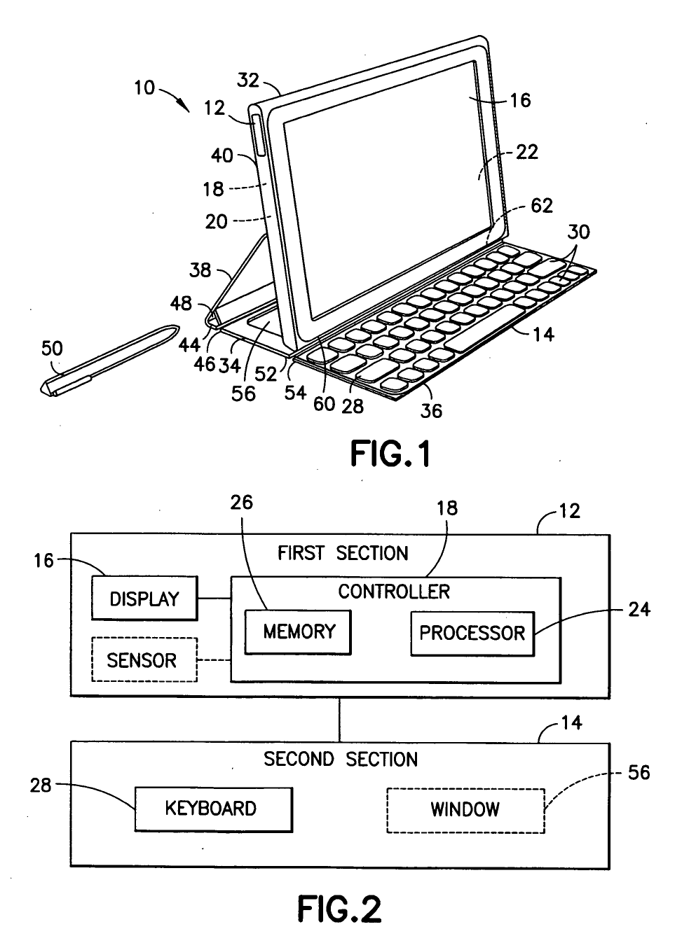

Referring to FIG. 1, there is shown perspective view of an apparatus 10 incorporating features of an example embodiment. Although the features will be described with reference to the example embodiments shown in the drawings, it should be understood that features can be embodied in many alternate forms of embodiments. In addition, any suitable size, shape or type of elements or materials could be used.

The apparatus 10 is an electronic device similar to a laptop computer. However, features could be used in any suitable type of electronic device such as having applications such as Internet browsing, computer applications, etc. Referring also to FIG. 2, the apparatus 10 generally comprises a first section 12 and a second section 14. In this example embodiment the first section 12 generally comprises a display 16, a controller and a rechargeable battery 20. Circuitry 22 inside the first section comprises other components such as a transmitter, a receiver, and other components well known in laptop computers and tablet communication devices. The display 16 is a touch screen which is adapted to be used as an input device as well as a display device. However, in an alternate embodiment the display might not be a touch screen. The controller 18 generally comprises at least one processor 24 and at least one memory 26.

The second section 14 comprises a keyboard 28 having keys 30. The first and second sections 12, 14 form an overall housing for the apparatus 10. In this example, the first section 12 has a housing section 32 which, although comprised of multiple pieces, is generally monolithic. The housing section 32 may have, for example, the removable battery as part of the exterior, or flaps or doors at various connectors, but the overall perception is similar to a tablet type of handheld device.

The housing configuration of the second section includes housing members which form a first portion 34, a second portion 36 and a connecting member 38. The second portion 36 has the keyboard 28 thereon. The connector member 38 is pivotably connected to a middle section of a rear side 40 of the first section 12. The first and second portions 34, 36 are connected in series to the first section 12 by the connecting member 38. The connecting member 38 has a substantially flat plate-like shape except at its two opposite ends; an end pivotably connected to the housing section 32 at the rear side of the first section 12, and end 44 pivotably connected to an end 46 of the first portion 34. In this embodiment the end 44 has a receiving space or slot 48 which is sized and shaped to removably receive a stylus 50. However, in an alternate embodiment the stylus 50 and the receiving space 48 might not be provided.

The first portion 34 has a substantially flat plate-like shape except at its two opposite ends; end 46 pivotably connected to the end 44 of the connecting member 38, and end 52 pivotably connected to an end 54 of the second portion 36. In this example the first portion comprises a window 56. The window 56 comprises transparent plastic. However, in an alternate embodiment the window 56 could be open or could comprise a transparent touch screen. In another alternate embodiment the window 56 might be replaced by a second display screen, or perhaps not provided at all.

The second portion 36 has the keyboard 28 with the keys 30. Unlike a virtual keyboard provided on a touch screen, the keys 30 allow tactile feel to the user. Thus, a user can use touch typing with the keyboard. The end 54 is pivotably connected to the end 52 of the first portion 34.

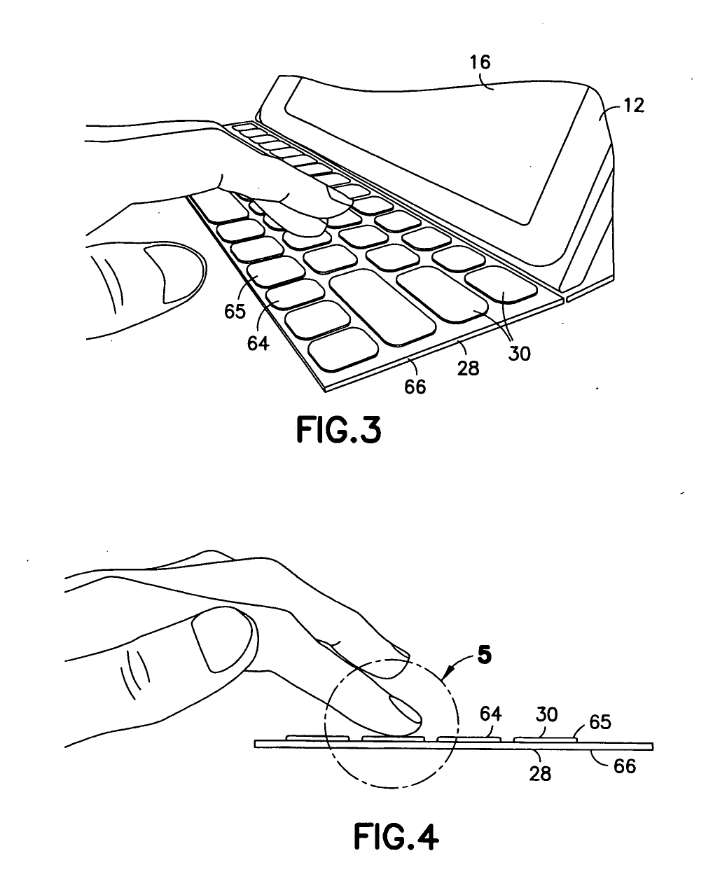

The housing configuration of the apparatus provides a variable form factor. In other words, the apparatus 10 can be configured into different forms or configurations. FIGS. 1 and 3 shows the apparatus 10 in a first configuration, such as on a desktop surface for example. In this first configuration the first and second portions 34, 36 can lay flat against the surface. Thus, the keyboard 28 is appropriately supported by the surface for the user to type on the keyboard 28. The first section 12 is supported on the second section 14 by the connection of the connecting member 38 against the rear side 40 and location of the side 60 of the housing section 32 on top of the second section 14 proximate the joint of the first and second portions 34, 36. The side and second section 14 could have a suitable system, such as a disconnectable mechanical latch or interlock, or a magnet attachment system 62 to keep the side 60 at the position shown; at least until a user desires to reconfigure the apparatus to a different configuration. In the first configuration shown, the keyboard 28 generally extending forward from a bottom side of a front of the display at an angle. Stated another way, the display 16 is angled for proper viewing by the user sitting at a chair at the desk. Additional configurations, such as the cover (formed by the first and second portions 34, 36) covering the display 16 are described in U.S. patent application Ser. No. 13/270,769 filed Oct. 11, 2011 which is hereby incorporated by reference in its entirety.

It should be noted that the example embodiment shown in FIGS. 1-3 is merely an example. Features of the keyboard 28 could be in an apparatus separate from the tablet 12, such as a standalone keyboard, or a keyboard attached to a removable tablet cover. Also, features described herein could be used in an apparatus other than a keyboard, such as any suitable keypad for example.

Referring particularly to FIGS. 3-7, the keyboard 28 generally comprises a keypad 64 on a support 66. The support 66 may be part of the keypad. The keypad 64 comprises the keys 30. In this example, the keypad 64 is comprised of a one-piece molded polymer member 65 forming a web section 68 and at least part of the keys 30. The keys 30 extend up from the web section 68. The keyboard 28 further comprises pressure sensors 70 and electrotactile feedback electrodes 72.

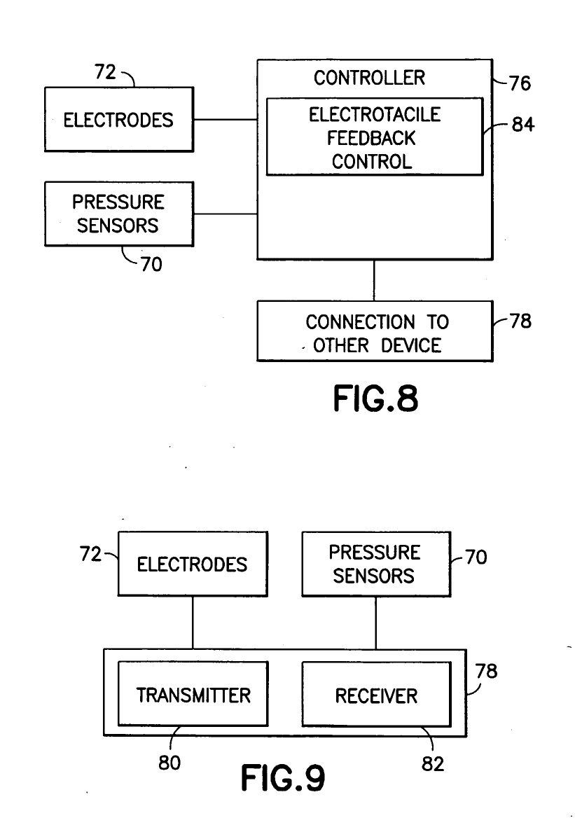

The sensors 70 are located on the top side of the support 66 with at least one sensor 70 located under the top surface 74 of each key 30. Electrical conductors (not shown) on the support 66 connect the sensors 70 to another component, such as a controller 76 of the keyboard (see FIG. 8), and/or to the controller 18 on the tablet 12. For example, as shown in FIG. 8 the keyboard controller 76 is connected to a connection 78 to another device, such as tablet 12. The connection 78 could be a physical wired connection or a wireless connection for example. As seen in FIG. 9, the connection 78 could include a wireless transmitter 80 and wireless receiver 82, such as BLUETOOTH for example, and the keyboard does not need a controller if the controller 18 of the tablet 12 is being used.

The pressure sensors 70 are configured to sense pressure applied to the top surface 74 of the keys 30 by fingers F of the user. In one type of example embodiment the pressure sensors might be able to signal different amounts of pressure. In another type of example embodiment the pressure sensors might only to configured to signal whether or not a single predetermined pressure has been surpassed. In another type of example embodiment the pressure sensors might merely be an ON/OFF switch. Thus, in all of these examples, the sensor 70 is able to send a signal when its respective key has been actuated. Referring to FIG. 8, this key-stroke signal may be sent to the controller 76 and to the tablet 12 via the connection 78. As illustrated by the example of FIG. 9, alternatively or additionally this key-stroke signal may be sent directly to the tablet by the connection 78.

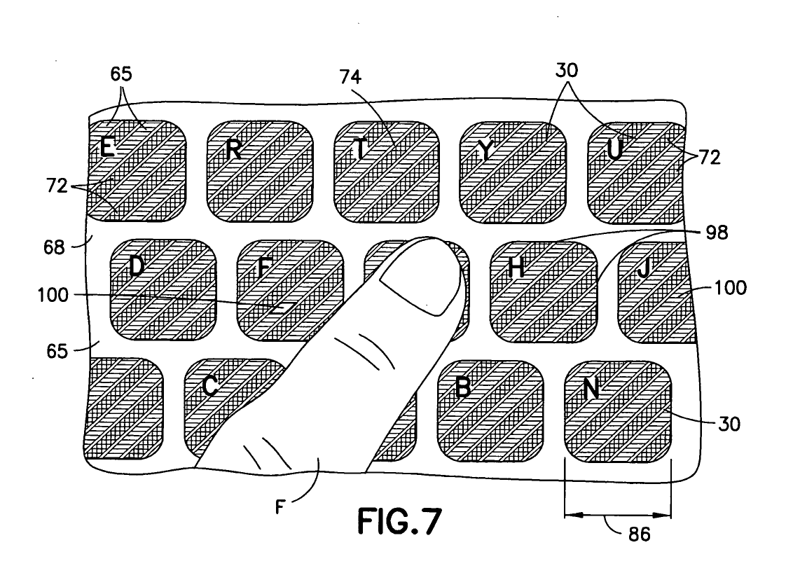

The electrodes 72 are electrotactile feedback electrodes intended to supply electricity to the skin of the finger F which actuates the respective key for that electrode. In the example embodiment illustrated in FIG. 7, each top surface 74 of the keys 30 has at least one of the electrodes 72. The electrodes 72 are exposed at the top surfaces. Thus, there is direct physical contact of the skin of the finger F onto the electrode 72 when a user presses against the top surface 74 of the keys. In the example shown, each top surface 74 has multiple electrodes 72 arranged in a general diagonal shape across the top surface. However, in alternate embodiments any suitable design of the electrode could be provided, and each top surface 74 might only have one electrode, such as circular or coil shaped for example. The dielectric material of the member 65 is located between the electrodes on each top surface 74. However, in an alternate embodiment the top surface 74 of each key might merely be all metal keytop; the member 65 being located under the metal keytop. In one type of method of manufacturing the keypad the member 65 is molded onto the electrodes 72 to integrally form the member 65 onto the electrodes 72 as a one-piece member.

The electrodes 72 are electrically connected by conductors on the support 66 to the controller 76 as illustrated in FIG. 8. Alternatively and/or additionally, the electrodes 72 are connected to the device 12 by a connection, such as connection 78 illustrated in FIGS. 8 and 9. In the example shown in FIG. 8, the keyboard controller 76 comprises an electrotactile feedback control 84. The control 84 could be provided in the tablet 12. The control 84 is configured to selectively send electricity to the electrodes 72. The control 84 could be configured to send a single predetermined voltage of electricity, or could be configured to send different voltages of electricity. In addition, the controller 84 could be configured to send the voltage as a substantially constant single pulse, or perhaps multiple pulses, and time durations of the pulses and times between the pulses could be varied.

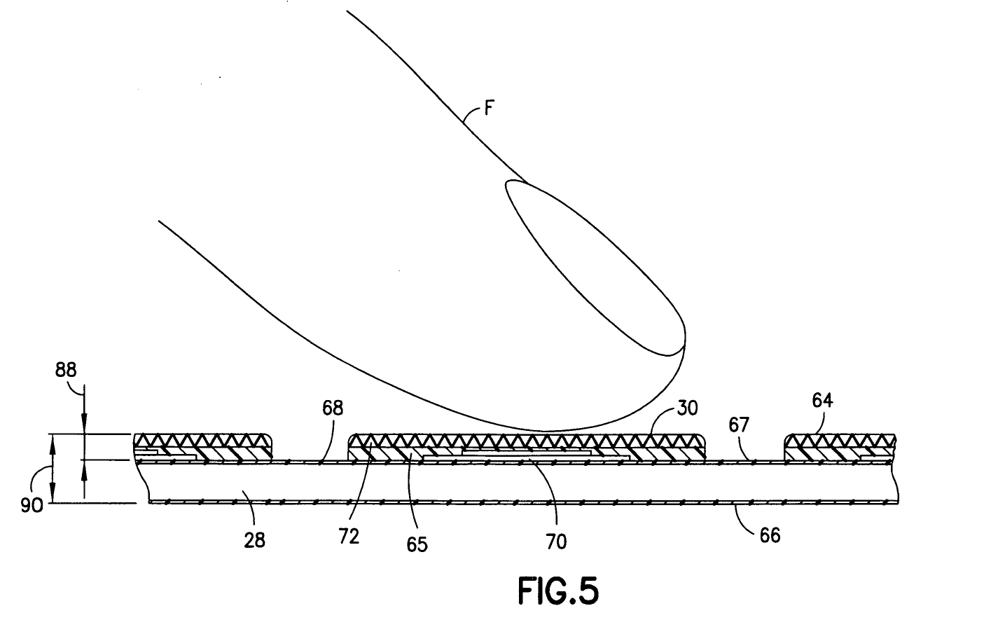

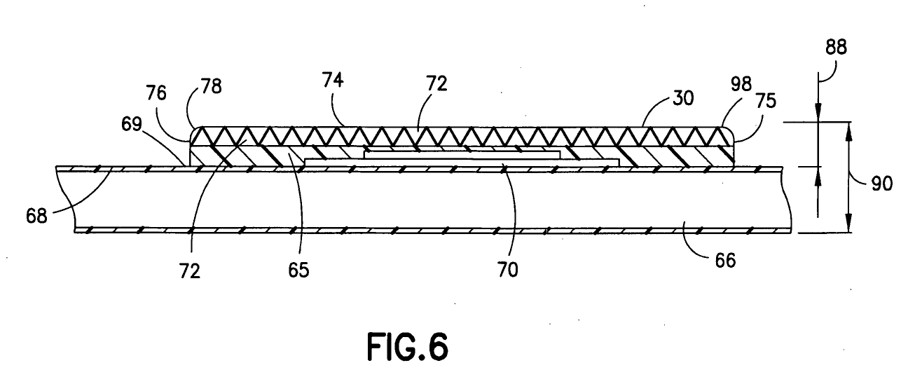

Referring particularly to FIGS. 5-7, the keys include alphabet keys and other keyboard keys. The alphabet keys have a width 86 (see FIG. 7). The keys 30 have a height 88 (see FIGS. 5 and 6). The height 88 of each of the keys is about 10 percent or less than the width 86 of the respective key. The height 90 of the keyboard 28 (see FIGS. 5 and 6) is about 20 percent or less than the width 86 of one of the alphabet keys. Thus, the height 88 of the keys is relatively small. As shown best in FIGS. 5 and 6, the sensors 70 are located under the top surfaces 74 of the keys. Portions of the member 65, forming the side walls of the keys, extend down from the top surface to the web section 68. These portions forming the side walls are located at lateral sides of the sensors 70. Because the member 65 is made or resilient polymer material, these portions are able to deform as a user presses down on the top surface of a key to allow the keytop to press down on the sensor 70. The amount of distance of downward movement of the top surface necessary to actuate the sensor 70 is relatively small compared to a conventional vertically movable key, such as only about 2 mm or less for example. In one example embodiment the height of the keyboard stroke is very small, such as about 0.3-0.4 mm for example. For some users, this relatively small amount of movement might not always be perceptible. However, with the addition of the electrotactile feedback system, the perception is enhanced.

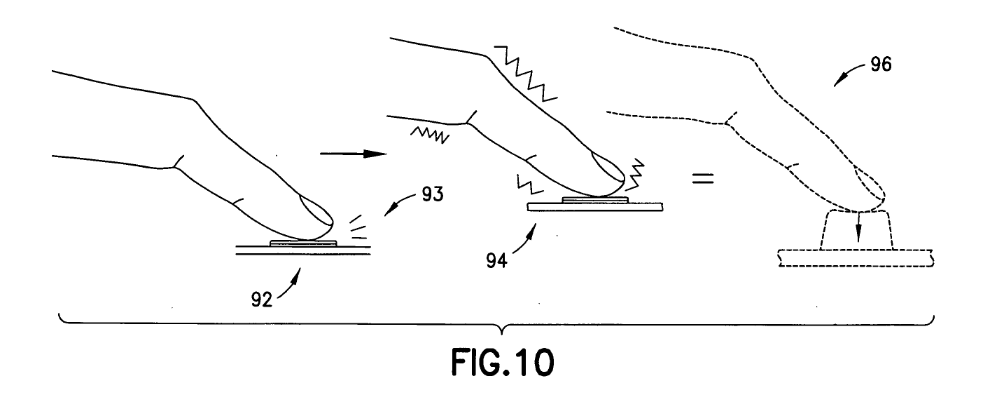

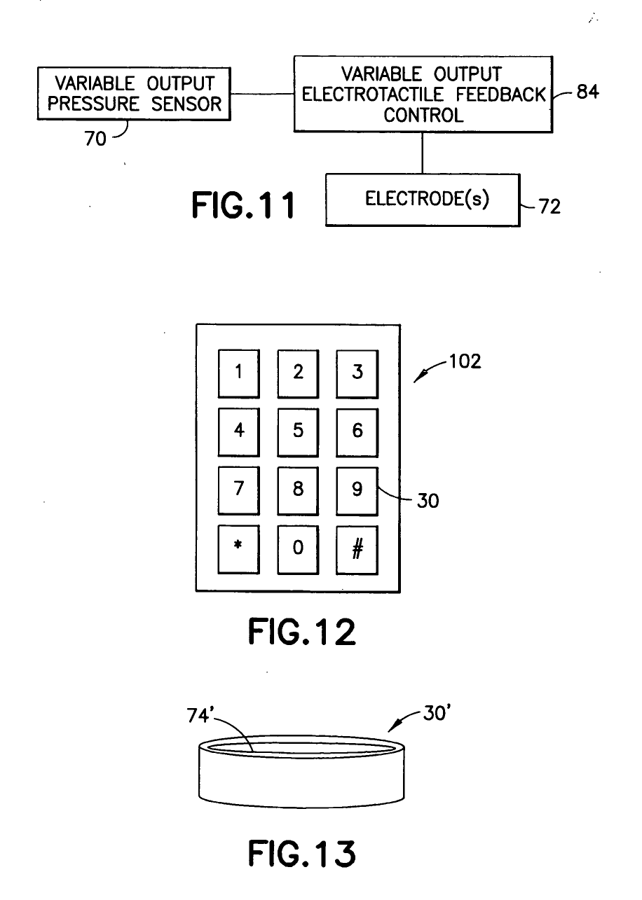

When a user presses down on one of the keys 30, the keytop resiliently deflects downward/inward to actuate the pressure sensor 70. The pressure sensor 70 for that key sends a key-stroke signal to the controller. The controller, perhaps in addition to performing a conventional operation for a key-stroke, allows the electrotactile feedback control 84 to send a pulse of electricity to the electrode(s) 72 at the top surface 74 of that key. This electricity is delivered from the electrode 72 directly to the skin of the finger F pressing the key; resulting in an electrotactile sensation to the user's finger. As illustrated in FIG. 10, the physical depression of the keytop provides an actually downward movement sensation as illustrated by 92. This sensation 92 combines with the electrical stimulation as illustrated by 94 to provide a combined hybrid sensation to the user of a longer (deeper) key-stroke as illustrated by 96.

Example embodiments comprising features described herein can be used to reproduce particular tactile sensations; namely, a much deeper or vertically longer stoke physical keystroke 96. Example embodiments comprising features described herein can be used to produce electrotactile feedback with force feedback. By setting a force sensor (load cell) under the electrodes, finger pressure can be measured. The applied pulse height or width can be set as a monotonically increasing function (possibly linear, or logarithmic) of this pressure. Therefore, an example embodiment can control the amount of sensation by regulating finger pressure. This is illustrated in FIG. 11 where the pressure sensors are variable output pressure sensors, and the electrotactile feedback control 84 is configured to output different outputs to the electrodes 72 based upon the input from the sensors 70.

Example embodiments comprising features described herein can use electrical stimulation to trigger muscular contractions. For the user, the neuromuscular electrical stimulation causes a pseudo-hapitic feedback sensation. Electrotactile sensations vary over time. The sensation threshold current for electrotactile (electrocutaneous) stimulation increases and decreases over time with a period of 3-10 min. The magnitude of these variations ranges from unmeasurably small to 25 percent of the average sensation threshold. However, example embodiments comprising features described herein can combine electrotactile sensations with a physical keytop shape sensation to produce a combined result which reduce sensation variation or reduction. In other words, even if the deflection of the keytop is very small, there is still a sensation to the user from the edges 98 of the top surfaces 74 of the keys, and the F and J keys can have a raised marker 100 (see FIG. 7).

Example embodiments comprising features described herein can provide a design for an extremely thin and light keyboard. This keyboard can be paired with a tablet 12 (as an accessory or as a combined tablet and keyboard apparatus 10), although the keyboard can be used with any computing device. Each individual key on the keyboard/keypad may consists of:
a platform that the user presses (i.e., the key);
a sensor that detects the user pressing the key (generally a pressure sensor); and
a system that provides electrotactile feedback, comprised of wires and small electrodes.

When the sensor detects that a key has been pressed, the user receives feedback (in the form of mild (and safe) electrical stimulation) that the key has been pressed.

Physical keyboards are more effective than soft keyboards because they provide feedback to users in two ways. First, the boundary between keys and the raised markers on the “F” and “J” keys allows users to touch type. Second, the spring of the key and perhaps the audible “click” 93 lets users know that they pressed a key. With feedback, users do not need to look at the keyboard when typing. Thus, the user can touch-type without looking at the keyboard.

Example embodiments comprising features described herein can provide a keyboard design which allows users to touch type. The keyboard still uses physical keys so that users can touch type. However, electrical feedback replaces the standard up-and-down mechanical motion of the keys in a standard keyboard. This means the keys can be much thinner in the vertical plane. Electrotactile feedback is applied to the finger to virtually mimic the full-stroke keyboard tactile feedback when the key is pressed as illustrated by 96 in FIG. 10.

This design can be used for any type of keypad including a physical keyboard or a numeric keypad for example. It is also applicable to other devices with buttons (e.g., the ON/OFF keypad button for a gaming console). Because there may be variations in users' threshold for electrotactile sensation, the actual amount of current may vary across users and time. The variable output electrotactile feedback control 84 shown in FIG. 11 could be, at least partially, user controlled. In other words, the user could select the setting to use. The control 84 could be at least partially automated to vary depending upon predetermined factors, such as duration of key-strokes over time (perhaps indicating finger fatigue) or battery life of the keyboard battery and/or the battery of the device 12 for example.

Advantages include incorporating features on alphanumeric keyboards and/or numeric keypads such as the keypad 102 shown in FIG. 2 for example; creating a thinner and lighter keyboard design; providing features on a keyboard with an alphanumeric input; and/or providing features on a keypad with numeric input (e.g., a standard phone keypad with 0-9, #, *).

An example embodiment may be provided in an apparatus 10 or 28 or 102 comprising a keypad comprising a plurality of keys 30, where each of the plurality of keys has a top surface 74 and sides 75 extending down from the top surface; pressure sensors 70 located under the top surfaces of the keys; and electrotactile feedback electrodes 72 located at the top surfaces of the keys.

The keypad may comprise a one-piece member 65 having a web section 68 integrally formed with the plurality of keys 30 and connected to bottoms 69 of the keys. The keys may be comprised of a resilient material and extend from a top side of a main section 67 of the keypad, where the keys are stationarily located on the main section, and where the keys are at least partially resiliently deformable in a direction towards the main section. A height of each of the keys may be about 10 percent or less than a width of the respective key. The apparatus may comprise a keyboard 28, where the keypad is part of the keyboard, and where the keys comprise alphabet keys. A height of the keyboard may be about 20 percent or less than a width of one of the alphabet keys. The apparatus may comprises a plurality of the electrodes on each of the keys. The electrodes may extend diagonally across the top surfaces of the keys. The apparatus may further comprise a controller 76 connected to the pressure sensors and the electrodes, where the controller is configured to vary voltage of electricity sent to the electrodes based upon an amount of force sensed by a respective one of the pressure sensors located under the electrodes. Each of the keys may comprise a keytop comprising at least one of the electrodes and dielectric material on sides of the at least one electrode, where the dielectric material and the at least one electrode form the top surface 74, and where each of the keys comprises resiliently compressible material beneath the keytop and at lateral sides of their respective pressure sensor. At least an F alphabet key of the keys and a J alphabet key of the keys may have a raised marker 100. The top surfaces of the keys 30′ have a general concave shape 74′ as illustrated by FIG. 13. The apparatus may further comprising means for providing haptic feedback to a user from the keys when the user presses down on the keys.

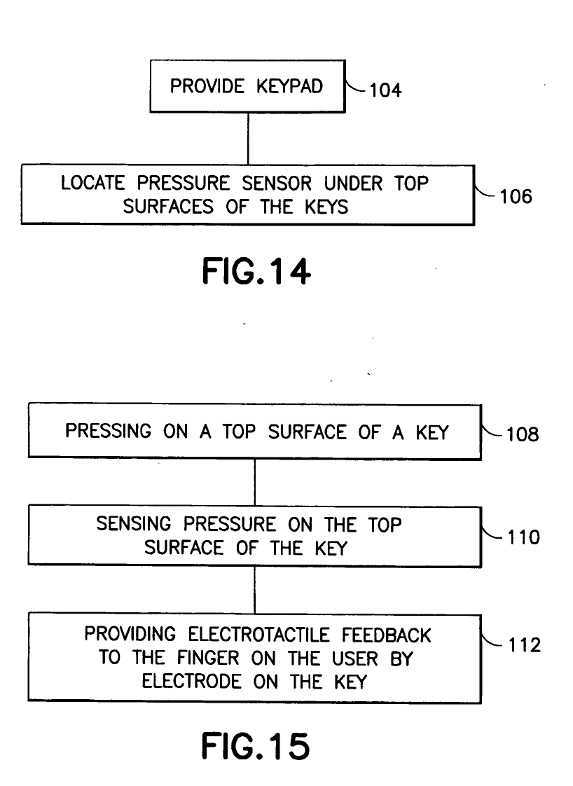

Referring also to FIG. 14, one example method may comprise providing a keypad as indicated by block 104 having a main section and a plurality of keys extending up from the main section, where each of the keys comprises a top surface and sides extending down from the top surface to the main section, and electrotactile feedback electrodes located at the top surfaces of the keys; and locating pressure sensors under the top surfaces of the keys as indicated by block 106.

Providing the keypad may comprise molding the keys with a web section connecting bottoms of the keys as a molded one-piece member, where the molded one-piece member is molded onto the electrodes. Each of the keys may comprise a keytop comprising at least one of the electrodes and dielectric material on sides of the at least one electrode, where the dielectric material and the at least one electrode form the top surface, and where each of the keys comprises resiliently compressible material beneath the keytop which is located at lateral sides of the pressure sensors when the pressure sensors are located under the top surfaces. Providing the keypad may comprise molding the keys with a web section connecting bottoms of the keys as a molded one-piece member, where the keys are molded with a height of each of the keys being about 10 percent or less than a width of the respective key. The keypad may form part of a keyboard, where the keys comprise alphabet keys, and where a height of the keyboard is about 20 percent or less than a width of one of the alphabet keys. The method may further comprise connecting the electrodes and the pressure sensors to a controller, where the controller is configured to vary voltage of electricity sent to the electrodes based upon an amount of force sensed by the respective pressure sensor located under the electrodes.

Referring also to FIG. 15, another example method may comprise pressing on a top surface of a key of a keypad by a finger of a user as indicated by block 108, where the keypad comprises a main section and the key extends up from the main section, where the key comprises the top surface located above the main section and sides of the key extending down from the top surface to the main section; sensing pressure on the top surface of the key by a pressure sensor located under the top surface as indicated by block 110; and providing electrotactile feedback to the finger of the user by an electrode on the top surface of the key as indicated by block 112. The method may further comprise providing different amounts of voltage of electricity sent to the electrode based upon an amount of force sensed by the pressure sensor located under the electrode.

In one example, a non-transitory program storage device 12, 26 or such as a CD-ROM or flash memory module for example readable by a machine, tangibly embodying a program of instructions executable by the machine for performing operations, may be provided where the operations comprise sensing pressing on a top surface of a key of a keypad by a finger of a user by a pressure sensor located under the top surface, where the keypad comprises a main section and the key extends up from the main section, where the key comprises the top surface located above the main section and sides of the key extending down from the top surface to the main section; and providing electricity to an electrode on the top surface of the key to provide electrotactile feedback to the finger of the user. The operations may further comprise providing different amounts of voltage of electricity to the electrode based upon an amount of force sensed by the pressure sensor located under the electrode.

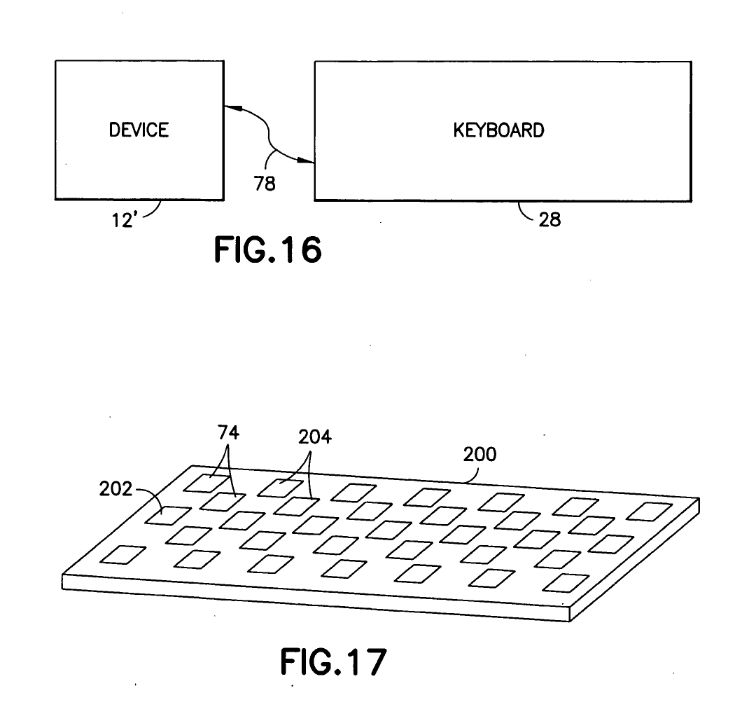

Referring also to FIG. 16, as noted above the keyboard 28 does not need to be part of the apparatus 10. The keyboard 28 could be a standalone apparatus. The keyboard 28 could be connected to another device 12′ such as by a connection 78. The other device 12′ could be a laptop computer, a tablet, a mobile phone, a desktop computer, a television set-top box or television for example. This example illustrates that an electrotactile keyboard/keypad can be paired with a variety of devices, including a laptop, tablet, and/or mobile phone. The connection 78 could be a wired connection or a wireless connection, such as BLUETOOTH, wireless LAN, optical or other radio frequency for example.

Referring also to FIG. 17 an alternate example embodiment of the keyboard is shown. In this example the keyboard 200 has a keypad with a substantially flat top surface 202. The keys 204 are printed or otherwise permanently formed to be visible at the top surface 202. The top surfaces 74 of the keys 204 are flush with the top surface 202. In one type of example the F and J keys could have marker protrusions.

This example illustrates that, although electrotactile feedback can be used to augment a keyboard stroke, electrotactile feedback can be used on a keyboard/keypad 200 where the keys 204 do not have a key stroke. With electrotactile feedback, the keyboard could potentially be completely flat. For example, the surface 202 could be made of some electrically conductive material printed with a keyboard. When the user touches the surface 202, the feedback will make the keyboard feel as though the user had down-pressed a key of a keyboard having vertically movable keys. Unlike a touchscreen having tactile feedback, the keyboard 200 does not have a display screen, and the feedback provided by the keyboard 200 is electrotactile. However, features could be used with a touchscreen on the keyboard.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
a keypad comprising a plurality of keys, where each of the plurality of keys has a top surface;
pressure sensors located under the top surfaces of the keys; and
electrotactile feedback electrodes located at the top surfaces of the keys.

2. An apparatus as in claim 1 where each of the plurality of keys has sides extending down from the top surface.

3. An apparatus as in claim 1 where the keypad has a top surface which is substantially flat and forms the top surfaces of the plurality of keys.

4. An apparatus as in claim 1 where the keypad comprises a one-piece member having a web section integrally formed with the plurality of keys and connected to bottoms of the keys.

5. An apparatus as in claim 1 where the keys are comprised of a resilient material and extend from a top side of a main section of the keypad, where the keys are stationarily located on the main section, and where the keys are at least partially resiliently deformable in a direction towards the main section.

6. An apparatus as in claim 1 where a height of each of the keys is about 10 percent or less than a width of the respective key.

7. An apparatus as in claim 1 where the apparatus comprises a keyboard, where the keypad is part of the keyboard, and where the keys comprise alphabet keys.

8. An apparatus as in claim 7 where a height of the keyboard is about 20 percent or less than a width of one of the alphabet keys.

9. An apparatus as in claim 1 where the apparatus comprises a plurality of the electrodes on each of the keys.

10. An apparatus as in claim 9 where the electrodes extends diagonally across the top surfaces of the keys.

11. An apparatus as in claim 1 further comprising a controller connected to the pressure sensors and the electrodes, where the controller is configured to vary voltage of electricity sent to the electrodes based upon an amount of force sensed by a respective one of the pressure sensors located under the electrodes.

12. An apparatus as in claim 1 where each of the keys comprise a keytop comprising at least one of the electrodes and dielectric material on sides of the at least one electrode, where the dielectric material and the at least one electrode form the top surface, and where each of the keys comprises resiliently compressible material beneath the keytop and at lateral sides of their respective pressure sensor.

13. An apparatus as in claim 1 where at least an F alphabet key of the keys and a J alphabet key of the keys have a raised marker.

14. An apparatus as in claim 1 where the top surfaces of the keys have a general concave shape.

15. An apparatus as in claim 1 further comprising means for providing haptic feedback to a user from the keys when the user presses down on the keys.

16. A method comprising:
providing a keypad having a main section and a plurality of keys extending up from the main section, where each of the keys comprises a top surface, and electrotactile feedback electrodes located at the top surfaces of the keys; and
locating pressure sensors under the top surfaces of the keys.

17. A method as in claim 16 where providing the keypad comprises molding the keys with a web section connecting bottoms of the keys as a molded one-piece member, where the molded one-piece member is molded onto the electrodes.

18. A method as in claim 16 where each of the keys comprise a keytop comprising at least one of the electrodes and dielectric material on sides of the at least one electrode, where the dielectric material and the at least one electrode form the top surface, and where each of the keys comprises resiliently compressible material beneath the keytop which is located at lateral sides of the pressure sensors when the pressure sensors are located under the top surfaces.

19. A method as in claim 16 where providing the keypad comprises molding the keys with a web section connecting bottoms of the keys as a molded one-piece member, where the keys are molded with a height of each of the keys being about 10 percent or less than a width of the respective key.

20. A method as in claim 19 where the keypad forms part of a keyboard, where the keys comprise alphabet keys, and where a height of the keyboard is about 20 percent or less than a width of one of the alphabet keys.

21. A method as in claim 16 further comprising connecting the electrodes and the pressure sensors to a controller, where the controller is configured to vary voltage of electricity sent to the electrodes based upon an amount of force sensed by the respective pressure sensor located under the electrodes.

22. A method comprising:
pressing on a top surface of a key of a keypad by a finger of a user, where the keypad comprises a main section and the key extends up from the main section, where the key comprises the top surface located above the main section;
sensing pressure on the top surface of the key by a pressure sensor located under the top surface; and
providing electrotactile feedback to the finger of the user by an electrode on the top surface of the key.

23. A method as in claim 22 further comprising providing different amounts of voltage of electricity sent to the electrode based upon an amount of force sensed by the pressure sensor located under the electrode.

24. A non-transitory program storage device readable by a machine, tangibly embodying a program of instructions executable by the machine for performing operations, the operations comprising:
sensing pressing on a top surface of a key of a keypad by a finger of a user by a pressure sensor located under the top surface, where the keypad comprises a main section and the key extends up from the main section, where the key comprises the top surface located above the main section; and
providing electricity to an electrode on the top surface of the key to provide electrotactile feedback to the finger of the user.

25. A device as in claim 24 where the operations further comprise providing different amounts of voltage of electricity to the electrode based upon an amount of force sensed by the pressure sensor located under the electrode.
